(19) United States
(12) Patent Application Publication
(10) Pub. No.: US 2020/0325281 A1
(43) Pub. Date: Oct. 15, 2020

(54) BLOCK COPOLYMER FOR PROTECTING METAL-BASED PARTS

(71) Applicant: Arkema France, Colombes (FR)

(72) Inventors: Quentin PINEAU, Evreux (FR); Mathieu Capelot, Bernay (FR)

(73) Assignee: Arkema France, Colombes (FR)

(21) Appl. No.: 16/087,967

(22) PCT Filed: Mar. 24, 2017
(86) PCT No.: PCT/EP2017/057115

§ 371 Date: Dec. 26, 2018

(30) Foreign Application Priority Data
Mar. 24, 2016 (FR) 1652585

(51) Int. Cl. C08G 81/02; C08J 3/12; C09D 5/08; C09D 187/00

(52) U.S. Cl. CPC C08G 81/028; C09D 187/005; C09D 5/08; C08J 3/122

(57) ABSTRACT

A block copolymer comprising at least one polyamide block, at least one polyolefin block and at least one alkylene block is described, where the block copolymer has a melt viscosity of 300 Pa·s to 20,000 Pa·s. A preparation process, a composition containing the block copolymer, a method for using the composition, a coated metal part and use of the block copolymer is also described.

### CROSS-REFERENCE TO RELATED APPLICATIONS

This is the national phase of International Application No. PCT/EP2017/057115, filed Mar. 24, 2017, which claims priority to French Application No. 1652585, filed Mar. 24, 2016. The disclosure of each of these applications is incorporated herein by reference in its entirety for all purposes.

### FIELD OF THE INVENTION

The invention relates to a block copolymer comprising at least one polyamide block, at least one polyolefin block and at least one alkylene block, to a process for preparing it, to a composition containing said block copolymer and to a process for using the composition.

The invention also relates to a use of the copolymer or of the composition for conferring anti-corrosion and/or adhesion properties on a component comprising a part comprising metal.

### DESCRIPTION OF THE BACKGROUND

In very diverse fields, metal components or structures are exposed to external attacks over a very long period of time, whether they are metal components exposed to air, to the surface of water or else under water. For example, bridge suspension cables are exposed to great temperature differences. The metal structures used for construction of homes undergo considerable external stresses. Boat hulls or propellers are exposed to long periods in salt water at diverse temperatures. Pipes or pipelines used in the off-shore field are themselves also exposed to long periods in salt water and at extreme pressures.

In these specific fields, metal structures have a long lifetime and must have efficient and long-lasting corrosion resistance.

For many years, means for improving corrosion resistance have been sought. Various approaches have been exploited in order to solve this technical problem. Research has been carried out on the structure of metal materials themselves. Anti-corrosion treatments, undergone by the material before it is installed, have also been developed, such as chromium and phosphate treatments. A final approach consists of the application of a coating to the metal component.

In the coating field, in particular the field of metal components, there is still progress to be made, since the material sought must satisfy a certain number of criteria. It must perfectly adhere, in particular to the metal component: the adhesion must be strong and long-lasting.

The coating must then have efficient and long-lasting corrosion resistance.

Finally, depending on the applications, the coating must be able to receive an additional coating. In this context, the coating sought must be able to have strong and long-lasting adhesion with material other than a metal component.

The applicant has discovered that block copolymers of particular structure solve the technical problem stated.

Said block copolymers are thermoplastic copolymers and are not rubbers. In other words, the block copolymer is not crosslinked and cannot therefore be a rubber.

In particular, the applicant has been able to note that these copolymers, which result in particular in this double performance: good adhesion with respect to metal components and/or good anti-corrosion properties, also have a good capacity of adhesion with respect to other plastic components.

A subject of the present invention is therefore a block copolymer comprising
at least one polyamide block,
at least one polyolefin block,
at least one alkylene block, and

having a melt viscosity ranging from 300 Pa·s to 20 000 Pa·s, in particular from 300 to 15 000 Pa·s, measured at 230° C. by oscillatory rheology.

### SUMMARY OF THE INVENTION

The invention relates to a process for preparing such a block copolymer.

The invention also relates to a composition comprising at least one such block copolymer.

The invention relates to a process for using said composition.

A subject of the present invention is also a use of the block copolymer or of the composition for conferring anti-corrosion and/or adhesion properties on a component comprising a part comprising metal, in which said part is coated with said copolymer.

Other features, aspects, subjects and advantages of the present invention will emerge even more clearly on reading the description and the examples that follow.

Furthermore, any range of values denoted by the expression “between a and b” represents the range of values from a to b (that is to say limits a and b included), likewise any range of values denoted by the expression “from a to b” signifies the range of values from a up to b (that is to say including the strict limits a and b).

### DETAILED DESCRIPTION OF THE INVENTION

Block Copolymer

The block copolymer according to the present invention comprises:
at least one polyamide block,
at least one polyolefin block,
at least one alkylene block, and

has a melt viscosity ranging from 300 Pa·s to 20 000 Pa·s, in particular from 300 to 15 000 Pa·s, measured at 230° C. by oscillatory rheology.

The structure of these blocks is described below.

Polyamide Block

The block copolymers according to the invention comprise in their structure at least one polyamide block.

The nomenclature used to define polyamides is described in the standard ISO 1874-1:1992 “Plastics—Polyamide (PA) molding and extrusion materials—Part 1: Designation”, in particular on page 3 (tables 1 and 2), and is well known to a person skilled in the art.

The polyamide block according to the present invention can have a homopolyamide or copolyamide structure.

For the purposes of the present invention, the term “homopolyamide” is intended to mean a polyamide which consists only of the repetition of a single unit.

For the purposes of the present invention, the term “copolyamide” is intended to mean a polyamide which consists of the repetition of at least two units of different chemical structure. This copolyamide can exhibit a random, alternating or block structure.

The polyamide block according to the present invention can comprise one or more units with a structure chosen from amino acids, lactams and (diamine).(diacid) units.

When the polyamide comprises an amino acid in its structure, it can be chosen from 9-aminononanoic acid (A=9), 10-aminodecanoic acid (A=10), 10-aminoundecanoic acid (A=11), 12-aminododecanoic acid (A=12) and 11-aminoundecanoic acid (A=11) and its derivatives, in particular N-heptyl-11-aminoundecanoic acid, A denoting the number of carbon atoms in the unit.

When the polyamide comprises a lactam, it may be chosen from pyrrolidinone, 2-piperidinone, caprolactam, enantholactam, caprylolactam, pelargolactam, decanolactam, undecanolactam and lauryllactam (A=12).

When the polyamide comprises is a unit corresponding to the formula (Ca diamine).(Cb diacid), Ca and Cb denoting the number of carbon atoms respectively in the diamine and the diacid, the (Ca diamine) unit is chosen from linear or branched aliphatic diamines, cycloaliphatic diamines and alkylaromatic diamines.

When the diamine is aliphatic and linear, of formula H₂N—(CH₂)ₐ—NH₂, the (Ca diamine) monomer is preferably chosen from butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18), eicosanediamine (a=20), docosanediamine (a=22) and diamines obtained from fatty acids.

When the diamine is aliphatic, linear and unsaturated, the monomer (Ca diamine) is preferentially octadecenediamine (a=18).

When the diamine is aliphatic and branched, it can comprise one or more methyl or ethyl substituents on the main chain. For example, the (Ca diamine) monomer can advantageously be chosen from 2,2,4-trimethyl-1,6-hexanediamine, 2,4,4-trimethyl-1,6-hexanediamine, 1,3diaminopentane, 2-methyl-1,5-pentanediamine or 2-methyl-1,8-octanediamine.

When the (Ca diamine) monomer is cycloaliphatic, it is chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), bis(p-aminocyclohexyl)methane (PACM), isopropylidenedi(cyclohexylamine) (PACP), isophoronediamine (a=10), piperazine (a=4) or aminoethylpiperazine. It can also comprise the following carbon backbones: norbornylmethane, cyclohexylmethane, dicyclohexylpropane, di(methylcyclohexyl) or di(methylcyclohexyl)propane. A nonexhaustive list of these cycloaliphatic diamines is given in the publication “Cycloaliphatic Amines” (Encyclopedia of Chemical Technology, Kirk-Othmer, 4th Edition (1992), pp. 386-405).

When the (Ca diamine) monomer is alkylaromatic, it is chosen from 1,3-xylylenediamine and 1,4-xylylenediamine.

The (Cb diacid) unit is chosen from linear or branched aliphatic diacids, cycloaliphatic diacids and aromatic diacids.

When the (Cb diacid) monomer is aliphatic and linear, it is chosen from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18), octadecenedioic acid (b=18), eicosanedioic acid (b=20), docosanedioic acid (b=22) and fatty acid dimers containing 36 carbons.

The fatty acid dimers mentioned above are dimerized fatty acids obtained by oligomerization or polymerization of unsaturated monobasic fatty acids bearing a long hydrocarbon chain (such as linoleic acid and oleic acid), as described in particular in document EP 0 471 566.

When the diacid is cycloaliphatic, it can comprise the following carbon backbones: norbornylmethane, cyclohexylmethane, dicyclohexylmethane, dicyclohexylpropane, di(methylcyclohexyl) or di(methylcyclohexyl)propane.

When the diacid is aromatic, it is chosen from terephthalic acid (denoted T), isophthalic acid (denoted I) and naphthalenic diacids.

Preferably, the polyamide block is aliphatic.

More particularly, the polyamide block comprises at least one moiety chosen from PA 6, PA 11, PA12, PA 6.10, PA 6.6, PA 6.12, PA 10.10 and PA 10.12.

Even more particularly, the polyamide block comprises at least one moiety having a number of carbon atoms to nitrogen atom greater than or equal to 8, and more particularly comprises at least one moiety chosen from PA 11, PA12, PA 6.10, PA 6.12, PA 10.10 and PA 10.12.

Preferably, the polyamide block is chosen from homopolyamide blocks: PA 11, PA12, PA 6.10, PA 6.12, PA 10.10 and PA 10.12.

Preferably, the polyamide block(s) each have a number-average molecular weight, measured by potentiometery, of between 4000 and 20 000.

Preferably, the block copolymer according to the invention comprises a polyamide block content of between 2% and 98%, preferably between 30% and 95%, more preferably between 50% and 94% by weight relative to the total weight of the block copolymer.

Chain Ends

The polyamide block(s) can end with amine or acid functions, or can be functionalized so as to end with isocyanate and anhydride functions, and preferably end with amine functions.

Polyolefin Block

The block copolymers according to the invention comprise in their structure at least one polyolefin block.

The term “polyolefin” is intended to mean a homopolymer or copolymer comprising one or more olefin moieties, such as ethylene, propylene, 1-butene, 1-octene or butadiene moieties, or any other alpha-olefin. By way of example of a polyolefin, mention may be made of polyethylene and in particular low-density polyethylene (LDPE), high-density polyethylene (HDPE), linear low-density polyethylene (LLDPE) and very low-density polyethylene (VLDPE); polypropylene; ethylene/propylene copolymers; polyolefin elastomers such as ethylene-propylene (EPR or EPM) or ethylene-propylene-diene monomer (EPDM); or else metallocene polyethylenes obtained by single-site catalysis.

Advantageously, the term “polyolefin” is intended to mean a homopolymer or copolymer comprising one or more olefin moieties, such as ethylene, propylene, 1-butene, 1-octene or butadiene moieties, or any other alpha-olefin, with the exclusion of isoprene, which may or may not be chlorinated.

Preferably, the polyolefin block is polybutadiene.

It can comprise 1,4-cis, 1,4-trans or 1,2 sequences or a mixture thereof. Preferably, the polybutadiene comprises predominantly 1,2 sequences.

The block copolymer comprises a polyolefin block content of between 2% and 98%, preferably between 5% and 70%, more preferably between 6% and 50%, preferentially between 8% and 30%, and even more preferably between 9% and 25% by weight relative to the total weight of the block copolymer.

Chain Ends

The polyolefin block(s) can be functionalized so as to end with functions chosen from amines, acids, alcohols, isocyanates and anhydrides.

More preferably, the polyolefin block is a polybutadiene block which ends with alcohol functions.

The product with the trade name Krasol® or Poly Bd® sold by the company Cray Valley can be used.

Physicochemical Properties of the Polyolefin Block

The polyolefin block can have a viscosity of less than 60 000 cps, preferably less than 40 000 cps, and preferably less than 20 000 cps and more preferably between 1000 and 20 000 cps, the viscosity being measured at 25° C. with a Brookfield instrument and according to the Brookfield method.

Advantageously, the polyolefin block has a number-average molecular weight of between 1000 and 10 000, in particular between 1000 and 4000.

Intermediate Bonds Between the Blocks

The polyamide and polyolefin block(s) can end with functions chosen from amines, acids, isocyanates, alcohols and anhydrides. The polyolefin and polyamide block(s) can be modified so as to end with these functions.

Consequently, the bonds between the blocks can be ester, amide, urea and/or urethane functions.

Preferably, the polyolefin and polyamide blocks do not comprise side grafting. The term “side grafting” is intended to mean grafting which is not located at the ends of the block, but which is located on the main chain and which thus creates branching or substitution of the main chain.

Preferably, the copolymer according to the invention is linear.

Alkylene Block

The block copolymers according to the invention comprise in their structure at least one alkylene block.

For the purposes of the present invention, the term “alkylene block” is intended to mean a linear, saturated aliphatic chain.

The alkylene block(s) are connected to the other polymer blocks of the copolymer according to the invention by means of functions, such as those chosen from amines, acids, alcohols, isocyanates and anhydrides.

Preferably, the alkylene block is a C₂-C₃₆ diacid, more preferentially C₈-C_{36,} in particular C₁₀-C₃₆ diacid, that is to say that it is derived from a C₂-C_{36,} more preferentially C₈-C_{36,} in particular C₁₀-C₃₆ diacid. In other words, it is obtained following the condensation of a C₂-C_{36,} more preferentially C₈-C_{36,} in particular C₁₀-C₃₆ diacid monomer with the other blocks.

The alkylene block originates from the condensation of a telechelic monomer, that is to say of a monomer which is functionalized only at the ends and is capable of undergoing subsequent polycondensation due to the presence of reactive groups at each of the two ends of the chain. More preferably, the block copolymer according to the invention comprises at least one alkylene block which ends with acid functions.

Even more preferably, the block copolymer according to the invention comprises at least one alkylene block comprising between 8 and 36 carbon atoms, in particular C₁₀-C₃₆ alkylene block. More particularly, the alkylene block is a fatty diacid.

More particularly, the alkylene block is a fatty acid dimer or else a dimerized fatty acid, preferably a C₈-C₃₆ diacid.

Preferably, the block copolymer according to the invention is characterized by a particular arrangement: the alkylene block is between a polyamide block and a polyolefin block.

Consequently, the alkylene block acts as a linker between the polyamide and polyolefin polymer blocks.

The product with the trade name Pripol® sold by the company Croda can be used.

The product with the trade name Empol® sold by the company Cognis can be used.

The product with the trade name Unydime® sold by the company Arizona Chemical can be used.

The product with the trade name Radiacid® sold by the company Oleon can be used.

Arrangement of the Copolymer

According to a first embodiment, the block copolymer according to the invention has the following formula:

PA-(R-Pol)n-R-Pol-R-PA

with n between 0 and 100, in particular from 0 to 10, preferably 0 or 1,

PA denoting the polyamide block,

R denoting the alkylene block,

Pol denoting the polyolefin block.

According to a second embodiment, the block copolymer according to the invention has the following formula:

PA-(R-Pol-PA)n-R-Pol-R-PA
with n between 0 and 100, in particular from 0 to 10, preferably 0 or 1,
PA, R and Pol being as defined above.

According to a third embodiment, the block copolymer according to the invention has the following formula:

PA-(R-Pol-R-PA)n-R-Pol-R-PA
with n between 0 and 100, in particular from 0 to 10, preferably 0 or 1,
PA, R and Pol being as defined above.

Content of the Blocks

Preferably, the block copolymer according to the invention comprises an alkylene block content of between 0.1% and 25%, preferably between 1% and 15% by weight relative to the total weight of the block copolymer.

Advantageously, the block copolymer according to the invention comprises an alkylene block content of between 0.1% and 25%, a polyamide block content of between 2% and 98%, a polyolefin block content of between 2% and 98% by weight relative to the total weight of the block copolymer, the sum being equal to 100%.

Advantageously, the block copolymer according to the invention comprises an alkylene block content of between 0.1% and 25%, a polyamide block content of between 2% and 98%, a polyolefin block content of between 5% and 70% by weight relative to the total weight of the block copolymer, the sum being equal to 100%.

Advantageously, the block copolymer according to the invention comprises an alkylene block content of between 0.1% and 25%, a polyamide block content of between 2% and 98%, a polyolefin block content of between 6% and 50% by weight relative to the total weight of the block copolymer, the sum being equal to 100%.

Advantageously, the block copolymer according to the invention comprises an alkylene block content of between 0.1% and 25%, a polyamide block content of between 2% and 98%, a polyolefin block content of between 8% and 30% by weight relative to the total weight of the block copolymer, the sum being equal to 100%.

Advantageously, the block copolymer according to the invention comprises an alkylene block content of between 0.1% and 25%, a polyamide block content of between 2% and 98%, a polyolefin block content of between 10% and 25% by weight relative to the total weight of the block copolymer, the sum being equal to 100%.

Advantageously, the block copolymer according to the invention comprises an alkylene block content of between 0.1% and 25%, a polyamide block content of between 30% and 95%, a polyolefin block content of between 2% and 98% by weight relative to the total weight of the block copolymer, the sum being equal to 100%.

Advantageously, the block copolymer according to the invention comprises an alkylene block content of between 0.1% and 25%, a polyamide block content of between 30% and 95%, a polyolefin block content of between 5% and 70% by weight relative to the total weight of the block copolymer, the sum being equal to 100%.

Advantageously, the block copolymer according to the invention comprises an alkylene block content of between 0.1% and 25%, a polyamide block content of between 30% and 95%, a polyolefin block content of between 6% and 50% by weight relative to the total weight of the block copolymer, the sum being equal to 100%.

Advantageously, the block copolymer according to the invention comprises an alkylene block content of between 0.1% and 25%, a polyamide block content of between 30% and 95%, a polyolefin block content of between 8% and 30% by weight relative to the total weight of the block copolymer, the sum being equal to 100%.

Advantageously, the block copolymer according to the invention comprises an alkylene block content of between 0.1% and 25%, a polyamide block content of between 30% and 95%, a polyolefin block content of between 10% and 25% by weight relative to the total weight of the block copolymer, the sum being equal to 100%.

Advantageously, the block copolymer according to the invention comprises an alkylene block content of between 0.1% and 25%, a polyamide block content of between 50% and 94%, a polyolefin block content of between 2% and 98% by weight relative to the total weight of the block copolymer, the sum being equal to 100%.

Advantageously, the block copolymer according to the invention comprises an alkylene block content of between 0.1% and 25%, a polyamide block content of between 50% and 94%, a polyolefin block content of between 5% and 70% by weight relative to the total weight of the block copolymer, the sum being equal to 100%.

Advantageously, the block copolymer according to the invention comprises an alkylene block content of between 0.1% and 25%, a polyamide block content of between 50% and 94%, a polyolefin block content of between 6% and 50% by weight relative to the total weight of the block copolymer, the sum being equal to 100%.

Advantageously, the block copolymer according to the invention comprises an alkylene block content of between 0.1% and 25%, a polyamide block content of between 50% and 94%, a polyolefin block content of between 8% and 30% by weight relative to the total weight of the block copolymer, the sum being equal to 100%.

Advantageously, the block copolymer according to the invention comprises an alkylene block content of between 0.1% and 25%, a polyamide block content of between 50% and 94%, a polyolefin block content of between 10% and 25% by weight relative to the total weight of the block copolymer, the sum being equal to 100%.

Advantageously, the block copolymer according to the invention comprises an alkylene block content of between 0.1% and 25%, a polyamide block content of between 70% and 92%, a polyolefin block content of between 2% and 98% by weight relative to the total weight of the block copolymer, the sum being equal to 100%.

Advantageously, the block copolymer according to the invention comprises an alkylene block content of between 0.1% and 25%, a polyamide block content of between 70% and 92%, a polyolefin block content of between 5% and 70% by weight relative to the total weight of the block copolymer, the sum being equal to 100%.

Advantageously, the block copolymer according to the invention comprises an alkylene block content of between 0.1% and 25%, a polyamide block content of between 70% and 92%, a polyolefin block content of between 6% and 50% by weight relative to the total weight of the block copolymer, the sum being equal to 100%.

Advantageously, the block copolymer according to the invention comprises an alkylene block content of between 0.1% and 25%, a polyamide block content of between 70% and 92%, a polyolefin block content of between 8% and 30% by weight relative to the total weight of the block copolymer, the sum being equal to 100%.

Advantageously, the block copolymer according to the invention comprises an alkylene block content of between 0.1% and 25%, a polyamide block content of between 70% and 92%, a polyolefin block content of between 10% and 25% by weight relative to the total weight of the block copolymer, the sum being equal to 100%.

Advantageously, the block copolymer according to the invention comprises an alkylene block content of between 0.1% and 25%, a polyamide block content of between 75% and 90%, a polyolefin block content of between 2% and 98% by weight relative to the total weight of the block copolymer, the sum being equal to 100%.

Advantageously, the block copolymer according to the invention comprises an alkylene block content of between 0.1% and 25%, a polyamide block content of between 75% and 90%, a polyolefin block content of between 5% and 70% by weight relative to the total weight of the block copolymer, the sum being equal to 100%.

Advantageously, the block copolymer according to the invention comprises an alkylene block content of between 0.1% and 25%, a polyamide block content of between 75% and 90%, a polyolefin block content of between 6% and 50% by weight relative to the total weight of the block copolymer, the sum being equal to 100%.

Advantageously, the block copolymer according to the invention comprises an alkylene block content of between 0.1% and 25%, a polyamide block content of between 75% and 90%, a polyolefin block content of between 8% and 30% by weight relative to the total weight of the block copolymer, the sum being equal to 100%.

Advantageously, the block copolymer according to the invention comprises an alkylene block content of between 0.1% and 25%, a polyamide block content of between 75% and 90%, a polyolefin block content of between 10% and 25% by weight relative to the total weight of the block copolymer, the sum being equal to 100%.

Advantageously, the block copolymer according to the invention comprises an alkylene block content of between 1% and 15%, a polyamide block content of between 2% and 98%, a polyolefin block content of between 2% and 98% by weight relative to the total weight of the block copolymer, the sum being equal to 100%.

Advantageously, the block copolymer according to the invention comprises an alkylene block content of between 1% and 15%, a polyamide block content of between 2% and 98%, a polyolefin block content of between 5% and 70% by weight relative to the total weight of the block copolymer, the sum being equal to 100%.

Advantageously, the block copolymer according to the invention comprises an alkylene block content of between 1% and 15%, a polyamide block content of between 2% and 98%, a polyolefin block content of between 6% and 50% by weight relative to the total weight of the block copolymer, the sum being equal to 100%.

Advantageously, the block copolymer according to the invention comprises an alkylene block content of between 1% and 15%, a polyamide block content of between 2% and 98%, a polyolefin block content of between 8% and 30% by weight relative to the total weight of the block copolymer, the sum being equal to 100%.

Advantageously, the block copolymer according to the invention comprises an alkylene block content of between 1% and 15%, a polyamide block content of between 2% and 98%, a polyolefin block content of between 10% and 25% by weight relative to the total weight of the block copolymer, the sum being equal to 100%.

Advantageously, the block copolymer according to the invention comprises an alkylene block content of between 1% and 15%, a polyamide block content of between 30% and 95%, a polyolefin block content of between 2% and 98% by weight relative to the total weight of the block copolymer, the sum being equal to 100%.

Advantageously, the block copolymer according to the invention comprises an alkylene block content of between 1% and 15%, a polyamide block content of between 30% and 95%, a polyolefin block content of between 5% and 70% by weight relative to the total weight of the block copolymer, the sum being equal to 100%.

Advantageously, the block copolymer according to the invention comprises an alkylene block content of between 1% and 15%, a polyamide block content of between 30% and 95%, a polyolefin block content of between 6% and 50% by weight relative to the total weight of the block copolymer, the sum being equal to 100%.

Advantageously, the block copolymer according to the invention comprises an alkylene block content of between 1% and 15%, a polyamide block content of between 30% and 95%, a polyolefin block content of between 8% and 30% by weight relative to the total weight of the block copolymer, the sum being equal to 100%.

Advantageously, the block copolymer according to the invention comprises an alkylene block content of between 1% and 15%, a polyamide block content of between 30% and 95%, a polyolefin block content of between 10% and 25% by weight relative to the total weight of the block copolymer, the sum being equal to 100%.

Advantageously, the block copolymer according to the invention comprises an alkylene block content of between 1% and 15%, a polyamide block content of between 50% and 94%, a polyolefin block content of between 2% and 98% by weight relative to the total weight of the block copolymer, the sum being equal to 100%.

Advantageously, the block copolymer according to the invention comprises an alkylene block content of between 1% and 15%, a polyamide block content of between 50% and 94%, a polyolefin block content of between 5% and 70% by weight relative to the total weight of the block copolymer, the sum being equal to 100%.

Advantageously, the block copolymer according to the invention comprises an alkylene block content of between 1% and 15%, a polyamide block content of between 50% and 94%, a polyolefin block content of between 6% and 50% by weight relative to the total weight of the block copolymer, the sum being equal to 100%.

Advantageously, the block copolymer according to the invention comprises an alkylene block content of between 1% and 15%, a polyamide block content of between 50% and 94%, a polyolefin block content of between 8% and 30% by weight relative to the total weight of the block copolymer, the sum being equal to 100%.

Advantageously, the block copolymer according to the invention comprises an alkylene block content of between 1% and 15%, a polyamide block content of between 50% and 94%, a polyolefin block content of between 10% and 25% by weight relative to the total weight of the block copolymer, the sum being equal to 100%.

Advantageously, the block copolymer according to the invention comprises an alkylene block content of between 1% and 15%, a polyamide block content of between 70% and 92%, a polyolefin block content of between 2% and 98% by weight relative to the total weight of the block copolymer, the sum being equal to 100%.

Advantageously, the block copolymer according to the invention comprises an alkylene block content of between 1% and 15%, a polyamide block content of between 70% and 92%, a polyolefin block content of between 5% and 70% by weight relative to the total weight of the block copolymer, the sum being equal to 100%.

Advantageously, the block copolymer according to the invention comprises an alkylene block content of between 1% and 15%, a polyamide block content of between 70% and 92%, a polyolefin block content of between 6% and 50% by weight relative to the total weight of the block copolymer, the sum being equal to 100%.

Advantageously, the block copolymer according to the invention comprises an alkylene block content of between 1% and 15%, a polyamide block content of between 70% and 92%, a polyolefin block content of between 8% and 30% by weight relative to the total weight of the block copolymer, the sum being equal to 100%.

Advantageously, the block copolymer according to the invention comprises an alkylene block content of between 1% and 15%, a polyamide block content of between 70% and 92%, a polyolefin block content of between 10% and 25% by weight relative to the total weight of the block copolymer, the sum being equal to 100%.

Advantageously, the block copolymer according to the invention comprises an alkylene block content of between 1% and 15%, a polyamide block content of between 75% and 90%, a polyolefin block content of between 2% and 98% by weight relative to the total weight of the block copolymer, the sum being equal to 100%.

Advantageously, the block copolymer according to the invention comprises an alkylene block content of between 1% and 15%, a polyamide block content of between 75% and 90%, a polyolefin block content of between 5% and 70% by weight relative to the total weight of the block copolymer, the sum being equal to 100%.

Advantageously, the block copolymer according to the invention comprises an alkylene block content of between 1% and 15%, a polyamide block content of between 75% and 90%, a polyolefin block content of between 6% and 50% by weight relative to the total weight of the block copolymer, the sum being equal to 100%.

Advantageously, the block copolymer according to the invention comprises an alkylene block content of between 1% and 15%, a polyamide block content of between 75% and 90%, a polyolefin block content of between 8% and 30% by weight relative to the total weight of the block copolymer, the sum being equal to 100%.

Advantageously, the block copolymer according to the invention comprises an alkylene block content of between 1% and 15%, a polyamide block content of between 75% and 90%, a polyolefin block content of between 10% and 25% by weight relative to the total weight of the block copolymer, the sum being equal to 100%.

Advantageously, in the block copolymer according to the invention comprising a polyamide block, a polyolefin block and an alkylene block as defined above, the polyolefin block is a polybutadiene.

Advantageously, in the block copolymer according to the invention comprising a polyamide block, a polyolefin block and an alkylene block as defined above, the polyolefin block is a polybutadiene which ends with alcohol functions.

Advantageously, in the block copolymer according to the invention comprising a polyamide block, a polyolefin block and an alkylene block as defined above, the polyolefin block is a polybutadiene and the alkylene block is a C₈-C_{36,} in particular C₁₀-C₃₆ diacid.

Advantageously, in the block copolymer according to the invention comprising a polyamide block, a polyolefin block and an alkylene block as defined above, the polyolefin block is a polybutadiene and the alkylene block is a fatty diacid.

Advantageously, in the block copolymer according to the invention comprising a polyamide block, a polyolefin block and an alkylene block as defined above, the polyolefin block is a polybutadiene and the alkylene block is a fatty acid dimer.

Advantageously, in the block copolymer according to the invention comprising a polyamide block, a polyolefin block and an alkylene block as defined above, the polyolefin block is a polybutadiene which ends with alcohol functions and the alkylene block is a C₈⁻C_{36,} in particular C₁₀-C₃₆ diacid.

Advantageously, in the block copolymer according to the invention comprising a polyamide block, a polyolefin block and an alkylene block as defined above, the polyolefin block is a polybutadiene which ends with alcohol functions and the alkylene block is a fatty diacid.

Advantageously, in the block copolymer according to the invention comprising a polyamide block, a polyolefin block and an alkylene block as defined above, the polyolefin block is a polybutadiene which ends with alcohol functions and the alkylene block is a fatty acid dimer.

Viscosity

The block copolymer according to the invention has a melt viscosity ranging from 300 Pa·s to 20 000 Pa·s, in particular from 300 to 15 000 Pa·s, preferably ranging from 500 to 10 000 Pa·s, and more particularly from 500 to 5000 Pa·s measured at 230° C. by oscillatory rheology at a frequency of 1 Hz, 5% deformation, according to the standard ISO 6721-10:1999. The measurement method followed for carrying out this measurement is the following:

Plate-plate: 30 min at 230° C., 5% deformation according to the following operating conditions:
Device: PHYSICA MCR301
Geometry: parallel plates with a diameter of 25 mm
Temperatures: 230° C.
Frequency: 100 to 0.01 Hz
Duration: 10 minutes
Atmosphere: Flushing with nitrogen.

Chain Extender Block

The block copolymer according to the invention may optionally comprise at least one chain extender block.

This chain extender block has the structure:
Y1-A′-Y1
with A′ being a hydrocarbon-based biradical with a non-polymeric structure (neither polymer, nor oligomer, nor prepolymer),
bearing 2 identical end reactive functions Y1 (as defined in the formula above), which are reactive by polyaddition (without elimination of reaction by-product), with at least one chain-end function of the block copolymer according to the invention, preferably having a number-average molecular weight of less than 500 and more preferably of less than 400,
in particular, the reactive function Y1 is chosen from: oxazine, oxazoline, oxazolinone, oxazinone, imidazoline, epoxy, isocyanate, maleimide, cyclic anhydride.

As suitable examples of chain extenders, mention may be made of the following:
when the chain ends are NH₂ or OH functions, preferably NH₂ functions, the chain extender Y1-A′-Y1 corresponds to:
Y1 chosen from the following groups: maleimide, optionally blocked isocyanate, oxazinone and oxazolinone, cyclic anhydride, preferably oxazinone, anhydride and oxazolinone, and
A′ is a carbon-based spacer or radical bearing the reactive groups or functions Y1, chosen from:
a covalent bond between two functions (groups) Y1 in the case where Y1=oxazinone and oxazolinone or
an aliphatic hydrocarbon-based chain or an aromatic and/or cycloaliphatic hydrocarbon-based chain, the latter two comprising at least one optionally substituted ring of 5 or 6 carbon atoms, with optionally said aliphatic hydrocarbon-based chain optionally having a number-average molecular weight of 14 to 200 g.mol⁻¹.

The chain extender Y1-A′-Y1 may also correspond to a structure in which
Y1 is a caprolactam group and
A′ is a carbonyl radical such as carbonyl biscaprolactam or A′ possibly being a terephthaloyl or an isophthaloyl.

The chain extender Y1-A′-Y1 may also bear a cyclic anhydride group Y1 and preferably this extender is chosen from a cycloaliphatic and/or aromatic carboxylic dianhydride and more preferentially it is chosen from: ethylenetetracarboxylic dianhydride, pyromellitic dianhydride, 3,3′,4,4′-biphenyltetracarboxylic dianhydride, 1,4,5,8-naphthalenetetracarboxylic dianhydride, perylenetetracarboxylic dianhydride, 3,3′,4,4′-benzophenone tetracarboxylic dianhydride, 1,2,3,4-cyclobutanetetracarboxylic dianhydride, hexafluoroisopropylidene bisphthalic dianhydride, 9,9-bis(trifluoromethyl)xanthenetetracarboxylic dianhydride, 3,3′,4,4′-diphenylsulfonetetracarboxylic dianhydride, bicyclo[2.2.2]oct-7-ene-2,3,5,6-tetracarboxylic dianhydride, 1,2,3,4-cyclopentanetetracarboxylic dianhydride, 3,3′,4,4′-diphenyl ether tetracarboxylic dianhydride, or mixtures thereof
and
when the chain ends are COOH functions:
said chain extender Y1-A′-Y1 corresponds to:
Y1 chosen from the groups: oxazoline, oxazine, imidazoline, aziridine, such as 1,1′-iso- or tere-phthaloyl bis(2-methylaziridine), or epoxy,
A′ being a carbon-based spacer or radical as defined above.

More particularly, when, in said extender Y1-A′-Y1, said function Y1 is chosen from oxazinone, oxazolinone, oxazine, oxazoline or imidazoline, in particular oxazoline, in this case, in the chain extender represented by Y1-A′-Y1, A′ may represent an alkylene such as —(CH₂)ₘ— with m ranging from 1 to 14 and preferably from 2 to 10, or A′ may represent a cycloalkylene and/or an arylene which is (alkyl-) substituted or unsubstituted, for instance benzenic arylenes, such as o-, m- or p-phenylenes, or naphthalenic arylenes, and preferably A′ is an arylene and/or a cycloalkylene.

In the case where Y1 is an epoxy, the chain extender can be chosen from bisphenol A diglycidyl ether (BADGE), and its (cycloaliphatic) hydrogenated derivative bisphenol F diglycidyl ether, tetrabromo bisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether having Mn<500, polypropylene glycol diglycidyl ether having Mn<500, polytetramethylene glycol diglycidyl ether having Mn<500, resorcinol diglycidyl ether, neopentylglycol diglycidyl ether, bisphenol A polyethylene glycol diglycidyl ether having Mn<500, bisphenol A polypropylene glycol diglycidyl ether having Mn<500, diglycidyl esters of dicarboxylic acid, such as terephthalic acid glycidyl ester, or epoxidized diolefins (dienes) or fatty acids with a double epoxidized ethylenic unsaturation, diglycidyl 1,2-cyclohexanedicarboxylate, and mixtures thereof.

In the case of carbonyl- or terephthaloyl- or isophthaloyl- biscaprolactam as chain extender Y1-A′-Y1, the preferred conditions avoid the elimination of by-product, such as caprolactam during said polymerization and processing in the molten state.

In the optional case mentioned above where Y1 represents a blocked isocyanate function, this blocking can be obtained using agents for blocking the isocyanate function, for instance epsilon-caprolactam, methyl ethyl ketoxime, dimethylpyrazole or diethyl malonate.

Likewise, in the case where the extender is a dianhydride which reacts with NH₂ functions derived from the block copolymer, the preferred conditions prevent any formation of an imide ring during the polymerization and during the processing in the molten state.

For OH or NH₂ ends of the block copolymer, the group Y1 is preferably chosen from: anhydride, isocyanate (nonblocked), oxazinone and oxazolinone, more preferentially oxazinone and oxazolinone, with as spacer (radical) A′ being as defined above.

As examples of chain extenders bearing oxazoline or oxazine reactive functions Y that are suitable for the implementation of the invention, reference may be made to those described under references “A”, “B”, “C” and “D” on page 7 of application EP 0 581 642, and also to the processes for preparing same and the modes of reaction thereof which are disclosed therein. “A” in this document is bisoxazoline, “B” is bisoxazine, “C” is 1,3-phenylenebisoxazoline and “D” is 1,4-phenylenebisoxazoline.

By way of example, in the case where the CO₂H ends of the block copolymer and the chain extender Y1-A′-Y1 are 1,4-phenylenebisoxazoline, the reaction product obtained has at least one repeating unit having the following structure:
—O—C(O)—PA—C(O)—O—R1—NH—C(O)—A′-C(O)—NH—R1-
in which:
PA is a polyamide with acid ends HO—C(O)—PA—C(O)—OH as defined above,
R1 is (CH₂)₂, and
A′ is a phenyl.
As examples of chain extenders with an imidazoline reactive function Y1 that are suitable for the implementation of the invention, reference may be made to those described (“A” to “F”) on pages 7 to 8 and table 1 on page 10 of application EP 0 739 924, and also to the processes for preparing same and the modes of reaction thereof which are disclosed therein.

As examples of chain extenders with a reactive function Y1 =oxazinone or oxazolinone that are suitable for the implementation of the invention, reference may be made to those described under references “A” to “D” on pages 7 to 8 of application EP 0 581 641, and also to the processes for preparing same and the modes of reaction thereof which are disclosed therein.

As examples of oxazinone (6-atom ring) and oxazolinone (5-atom ring) groups Y1 that are suitable, mention may be made of the groups Y1 derived from: benzoxazinone, oxazinone or oxazolinone, with, as spacer, A′ possibly being a single covalent bond with respective corresponding extenders being: bis(benzoxazinone), bisoxazinone and bisoxazolinone.

A′ may also be a C1 to C14, preferably C2 to C10, alkylene, but preferably A′ is an arylene and more particularly it may be a phenylene (substituted with Y1 in positions 1,2 or 1,3 or 1,4) or a naphthalene radical (disubstituted with Y1) or a phthaloyl (iso- or terephthaloyl) or A′ may be a cycloalkylene.

For the functions Y1 such as oxazine (6-membered ring), oxazoline (5-membered ring) and imidazoline (5-membered ring), the radical A′ may be as described above with A′ possibly being a single covalent bond and with the respective corresponding extenders being: bisoxazine, bisoxazoline and bisimidazoline. A′ may also be a C1 to C14, preferably C2 to C10, alkylene. The radical A′ is preferably an arylene and more particularly it may be a phenylene (substituted with Y1 in positions 1,2 or 1,3 or 1,4) or a naphthalene radical (disubstituted with Y1) or a phthaloyl (iso-or terephthaloyl) or A′ may be a cycloalkylene.

In the case where Y1=aziridine (3-atom nitrogen-containing heterocycle equivalent to ethylene oxide with replacement of the ether —O— with —NH—), the radical A′ may be a phthaloyl (1,1-iso- or tere-phthaloyl) with, as an example of an extender of this type, 1,1′-isophtaloylbis(2-methylaziridine).

The presence of a catalyst of the reaction between the block copolymer and said extender Y1-A′-Y1 in a content ranging from 0.001% to 2%, preferably from 0.01% to 0.5%, relative to the total weight of two co-reactants mentioned, can accelerate the (poly)addition reaction and thus shorten the production cycle. Such a catalyst may be chosen from: 4,4′-dimethylaminopyridine, p-toluenesulfonic acid, phosphoric acid, NaOH and optionally those described for a polycondensation or transesterification as described in EP 0 425 341, page 9, lines 1 to 7.

According to a more particular case of the choice of said extender, A′ can represent an alkylene, such as —(CH₂)ₘ— with m ranging from 1 to 14 and preferably from 2 to 10, or represents an alkyl-substituted or unsubstituted arylene, such as benzenic arylenes (such as o-, m- or p-phenylenes) or naphthalenic arylenes (with arylenes: naphthalenylenes). Preferably, A′ represents an arylene which may be a substituted or unsubstituted benzenic or naphthalenic arylene.

Preferably, the chain extender is 3,3′,4,4′-benzophenone tetracarboxylic dianhydride. More particularly, the block copolymer ends with amine ends and 3,3′,4,4′-benzophenone tetracarboxylic dianhydride, used as chain extender, reacts with these amine ends.

As already specified, said chain extender has a nonpolymeric structure and preferably a number-average molecular weight of less than 500, more preferentially of less than 400.

Preferably, the block copolymer according to the invention comprises at least one chain extender block located at one or more polyamide ends of the copolymer.

According to a first embodiment, the block copolymer has the following formula:

(Y1-A′-Ya)-(copo blocs)-[(Ya-A′-Ya)-(copo blocs)]m-(Ya-A′ Y1)
in which
   copo blocs denotes the block copolymer as defined above,
   Ya-A′-Ya denotes a chain extender Y1-A′-Y1 as defined above for which the reactive functions Y1 have reacted with the ends of the block copolymer resulting in Ya functions,
   (Y1-A′-Ya) and -(Ya-A′ Y1) denote chain extenders in which a single function has reacted,
   m is an integer between 0 and 100.

According to a second embodiment, the block copolymer has the following formula:

X-(copo blocs)-(Ya-A′-Ya)-[(copo blocs)-(Ya-A′-Ya)]m-(copo blocs)-X
in which
   X denotes the free function of the block copolymer,
   the other elements having the same meanings as for the embodiment previously described.

The type of copolymer structure obtained will depend on the number of equivalents of chain extender introduced into the reaction medium during the preparation of said chain extender.

The content of said extender in said block polymer ranges from 1% to 20%, in particular from 5% to 20% by weight relative to the total weight of the block copolymer.

Advantageously, the block copolymer according to the invention comprises (or consists of)
at least one polyamide block, in which the content of polyamide block(s) is between 2% and 98% by weight relative to the total weight of the block copolymer,
at least one polyolefin block, in which the content of polyolefin block(s) is between 2% and 98% by weight relative to the total weight of the block copolymer,
at least one alkylene block, in which the content of alkylene block(s) is between 1% and 15% by weight relative to the total weight of the block copolymer, and
at least one chain extender block, in which the content of block(s) of said extender is from 1% to 20% relative to the total weight of the block copolymer, the total being equal to 100%.

Advantageously, in this last block copolymer according to the invention, said extender comprises reactive functions Y1, chosen from anhydrides, isocyanates (non-blocked), oxazinones and oxazolinones, more preferentially anhydride, oxazinone and oxazolinone, the spacer or the radical A′ being as defined above.

Advantageously, in the block copolymer according to the invention comprising (or consisting of) a polyamide block, an alkylene block or a polyolefin block as defined above, the content of said extender is from 5% to 20% relative to the total weight of the block copolymer, the total being equal to 100%.

Advantageously, in this last block copolymer according to the invention, said extender comprises reactive functions Y1, chosen from anhydrides, isocyanates (non-blocked), oxazinones and oxazolinones, more preferentially anhydride, oxazinone and oxazolinone, the spacer or the radical A′ being as defined above.

Molecular Weight

The block copolymer can have a number-average molecular weight measured by potentiometry of between 5000 and 50 000, preferably of between 7000 and 40 000 g/mol.

The number-average molecular weight is calculated according to the following formula: Mn=2/([COOH]+[NH₂]) in g/mol
with the concentrations of acid [COON] and amine [NH₂] chain ends in eq/g.

The potentiometric titration of the acid chain ends is carried out using tetra-n-butylammonium hydroxide in benzyl alcohol at 0.02 N.

The potentiometric titration of the amine chain ends is carried out using 0.02 N perchloric acid in m-cresol.

According to a first embodiment of the invention, when the block copolymer comprises a chain extender, then the polyamide block(s) each have a number-average molecular weight measured by potentiometry of between 4000 and 15 000.

According to a second embodiment of the invention, when the block copolymer does not comprise a chain extender, then the polyamide block(s) each have a number-average molecular weight measured by potentiometry of between 6000 and 15 000.

The block copolymer according to the invention is a thermoplastic copolymer and is not a rubber.

According to one preferred embodiment of the invention, the block copolymer comprises:
at least one polyamide block comprising an amine end, in which the content of polyamide block(s) is from 70% to 92% relative to the total weight of the block copolymer;
at least one polyolefin block, which is a polybutadiene, in which the content of polyolefin block(s) is from 10% to 25% relative to the total weight of the block copolymer;
at least one alkylene block, which is a C₈-C₃₆ diacid, in which the content of alkylene block(s) is from 1% to 15% relative to the total weight of the block copolymer; and
having a melt viscosity ranging from 300 Pa·s to 20 000 Pa·s, in particular from 300 to 15 000 Pa·s, measured at 230° C. by oscillatory rheology.

According to a second preferred embodiment of the invention, the block copolymer comprises:
at least one polyamide block comprising an amine end, in which the content of polyamide block(s) is from 70% to 92% relative to the total weight of the block copolymer;
at least one polyolefin block, which is a polybutadiene, in which the content of polyolefin block(s) is from 10% to 25% relative to the total weight of the block copolymer;
at least one alkylene block, which is a C₈-C₃₆ diacid, in which the content of alkylene block(s) is from 1% to 15% relative to the total weight of the block copolymer; and
at least one chain extender block in a content of from 1% to 20% relative to the total weight of the block copolymer,
having a melt viscosity ranging from 300 Pa·s to 20 000 Pa·s, in particular from 300 to 15 000 Pa·s, measured at 230° C. by oscillatory rheology.

Process for Preparing the Block Copolymer

The invention also relates to a process for preparing the block copolymer according to the invention.

The process for preparing the copolymer according to the invention comprises a step of mixing the various blocks.

Preferably, the process comprises the following successive steps:
a step of mixing the polyolefin and alkylene blocks, the molar ratio between polyolefin blocks and alkylene blocks being greater than or equal to ½, then
a step of mixing the polyamide block(s) with the mixture obtained in the preceding step.

The preparation process can comprise an additional step of mixing chain extender blocks as defined above with the mixture obtained in the preceding step.

Composition

The invention also relates to a composition comprising the block copolymer according to the invention.

Preferably, the composition is in the form of a powder or of granules.

Additives

The composition according to the invention may also comprise at least one additive.

This additive can in particular be chosen from processing aids, fillers, heat stabilizers, such as phosphite-based organic heat stabilizers or copper-based heat stabilizers, dyes, demolding agents, flame-retarding agents, surfactants, optical brighteners, antioxidants, such as those based on phenol or the product sold under the name Naugard 445® by the company Chemtura, anti-UV agents such as HALS, and mixtures thereof. Preferably, the dyes are present in a proportion of from 0% to 1.5%, in particular from 0.5% to 1% by weight, relative to the total weight of the composition. Preferably, the heat stabilizers are present in a proportion of from 0% to 2%, in particular from 0.5% to 1% by weight relative to the total weight of the composition, and the antioxidants are present in a proportion of from 0% to 2%, in particular from 0.5% to 1% by weight relative to the total weight of the composition.

The composition can also comprise catalysts, such as phosphoric acid or hypophosphorous acid (H₃PO₂, H₃PO₃ and H₃PO₄).

Among the processing aids, mention may be made of stearates, such as calcium or zinc stearates, natural waxes, and polymers comprising tetrafluoroethylene (TFE).

The weight proportion of processing aids is conventionally between 0.01% and 0.3% by weight, advantageously between 0.02% and 0.1% by weight, relative to the total weight of the composition.

Among the fillers, mention may be made of silica, graphite, expanded graphite, carbon black, glass beads, kaolin, magnesia, slag, talc, nanofillers (carbon nanotubes), pigments, metal oxides (titanium oxide), metals, fibers (aramid, glass, carbon fibers).

The fillers may be fibers or an assembly of fibers, preferably of long fibers, i.e. fibers having an aspect ratio defined by the ratio of length to diameter of the fiber, which means that these fibers have a circular cross-section, greater than 1000, preferably greater than 2000. In this assembly, the fibers may be continuous, in the form of a unidirectional (UD) or multidirectional (2D, 3D) reinforcer. In particular, they may be in the form of fabrics, sheets, strips or braids and may also be cut, for example in the form of nonwovens (mats) or in the form of felts.

These fibers may be chosen from:
mineral fibers,
polymeric fibers or mixtures of the fibers mentioned.

As mineral fibers suitable for the invention, mention may be made of carbon fibers, which include fibers of nanotubes or carbon nanotubes (CNTs), carbon nanofibers or graphenes; silica fibers such as glass fibers, in particular of E, R or S2 type; boron fibers; ceramic fibers, in particular silicon carbide fibers, boron carbide fibers, boron carbonitride fibers, silicon nitride fibers, boron nitride fibers, basalt fibers; fibers or filaments based on metals and/or alloys thereof; fibers of metal oxides, in particular of alumina (Al₂O₃); metallized fibers such as metallized glass fibers and metallized carbon fibers, or mixtures of the abovementioned fibers.

More particularly, these fibers may be chosen as follows:
the mineral fibers may be chosen from: carbon fibers, carbon nanotube fibers, glass fibers, in particular of E, R or S2 type, boron fibers, ceramic fibers, in particular silicon carbide fibers, boron carbide fibers, boron carbonitride fibers, silicon nitride fibers, boron nitride fibers, basalt fibers, fibers or filaments based on metals and/or alloys thereof, fibers based on metal oxides such as Al₂O₃, metallized fibers such as metallized glass fibers and metallized carbon fibers, or mixtures of the abovementioned fibers, and
the polymer or polymeric fibers are chosen from:
fibers of thermosetting polymers and more particularly those chosen from: unsaturated polyesters, epoxy resins, vinyl esters, phenolic resins, polyurethanes, cyanoacrylates and polyimides, such as bismaleimide resins, or aminoplasts resulting from the reaction of an amine such as melamine with an aldehyde such as glyoxal or formaldehyde,
thermoplastic polymer fibers, more particularly chosen from: polyethylene terephthalate (PET), polybutylene terephthalate (PBT), high-density polyolefins such as polyethylene (PET), polypropylene (PP) and PET/PP, PVOH (polyvinyl alcohol) copolymers,
fibers of polyamides corresponding to one of the formulae: 6, 11, 12, 6.10, 6.12, 6.6 and 4.6,
fibers of aramids (such as Kevlar®) and aromatic polyamides such as those corresponding to one of the formulae: PPD.T, MPD.I, PAA and PPA, with PPD and MPD being respectively p- et m-phenylenediamine, PAA being polyarylamides and PPA being polyphthalamides,
fibers of polyamide block copolymers such as polyamide/polyether, fibers of polyaryl ether ketones (PAEKs) such as polyether ether ketone (PEEK), polyether ketone ketone (PEKK) or polyether ketone ether ketone ketone (PEKEKK).

The preferred fibers are long fibers (with a circular cross-section) chosen from: carbon fibers, including those which are metallized, glass fibers, including those which are metallized, of E, R, S2 type, fibers of aramids (such as Kevlar®) or aromatic polyamides, polyaryl ether ketone (PAEK) fibers, such as polyether ether ketone (PEEK) fibers, polyether ketone ketone (PEKK) fibers, polyether ketone ether ketone ketone (PEKEKK) fibers, or mixtures thereof.

The fibers that are more particularly preferred are chosen from: glass fibers, carbon fibers, ceramic fibers and aramid fibers (such as Kevlar®), or mixtures thereof. These fibers have a circular cross-section.

Depending on the nature of the fillers, the amount of the latter may represent up to 70% by weight, in particular up to 60% by weight, in particular up to 40% by weight, more particularly up to 30% by weight, of the total weight of the composition.

Additional Polymers

A composition in accordance with the invention can also comprise one or more additional polymers, such a polymer being distinct from the block copolymer(s) mentioned above.

Advantageously, this additional polymer can in particular be chosen from a block copolymer other than that defined previously, a polyamide, a polyamide-block-ether, a polyetheramide, a polyesteramide, a polyphenylene sulfide (PPS), a polyphenylene oxide (PPO), a fluoropolymer, a natural rubber, a synthetic rubber, and mixtures thereof.

The additional polymer may also be chosen from starch, which may be modified and/or formulated, cellulose or derivatives thereof such as cellulose acetate or cellulose ethers, polylactic acid, polyglycolic acid and polyhydroxyalkanoates.

Preferably, the additional polymer is chosen from aliphatic polyamides and polyamide-block-ethers. Among the aliphatic polyamides, mention may in particular be made of long-chain polyamides, such as PA11, PA12, PA6.10, PA6.12, PA6.14, PA10.10, PA10.12 and PA12.12.

The composition can thus contain up to 20% by weight, relative to the total weight of the composition, of at least one additional polymer.

Process for Preparing the Composition

The invention also relates to a process for preparing the composition according to the invention.

This process comprises a step of incorporating the optional additives and additional polymers into the matrix of the block copolymer.

Process for Using the Composition or the Block Copolymer

The invention also relates to a process for using the composition according to the invention.

This process comprises a step of injecting, extruding or spraying the composition.

Use

The invention relates to the use of a block copolymer as defined above or of the composition as defined above, for protecting a component consisting completely or partly of metal.

Said component may be either a composite material as such, or a metal insert.

Preferably, the invention relates to this use for conferring on the metal-based material, to which it is applied, adhesion and/or anti-corrosion properties.

It has been observed, unexpectedly, that these block copolymers, of specific structure, have an affinity, in particular for metal surfaces or surfaces containing metal.

The copolymers according to the invention have an excellent adhesion on this type of surface.

They also have the advantage of protecting the coated surfaces against corrosion and against all external attacks that these surfaces may be subjected to.

These copolymers are thermoplastic copolymers and are not rubbers.

For the purposes of the present invention, the term “metal-based material” is intended to mean metal elements made completely or partly of metal or else plastic or elastic materials comprising metal fibers.

Consequently, the use according to the invention aims to confer anti-corrosion and/or adhesion properties on a component comprising a part comprising metal, in which said part is coated with said copolymer.

The examples that follow serve to illustrate the invention without, however, being limiting in nature.

### EXAMPLES

### I. Synthesis of the Block Copolymers

### 1/Synthesis of the Copolymer: Ref 1 (Comparative)

Polybutadiene and fatty acid dimer are mixed together in a molar ratio (polybutadiene/fatty acid dimer) of ½.

The mixture obtained is then mixed with the polyamide as described below.
Production of PA 11 diamine of number-average molecular weight 5000 g/mol:
33 kg of 11-aminoundecanoic acid, 0.716 kg of hexamethylenediamine, 33 g of Irganox 1098, 23.3 g of 85% orthophosphoric acid and 5 kg of deionized water are introduced into a 100 I autoclave equipped with a stirrer of Paravisc type. The medium is made inert with nitrogen then heated to 240° C. with stirring. The pressure is then 24 bar. When this temperature is reached, the pressure is brought back to atmospheric pressure by expansion and flushing under nitrogen is applied for 90 minutes.

The product obtained is thus emptied in water and recovered in the form of flakes.

The chain ends are titrated by potentiometry:
NH₂=0.368 meq/g
The molecular weight is 5434 g/mol.
   Production of a Pentabloc:
3.786 kg of Krasol® LBH-P 2000 (viscosity 13 000 cP, Mn=2100, 1.8 mol), 2.026 kg of Pripol® 1013 (M=575 g/mol, 3.6 mol), and 6.85 g of 85% orthophosphoric acid are introduced into a 100 I autoclave equipped with a stirrer of Paravisc type. The medum is stirred and is brought to a temperature of 220° C. under 200 mbar for 2 h. The medium is brought back to atmospheric pressure and cooled. 19.14 kg (3.6 mol) of the previously prepared polyamide are added. The medium is heated to 235° C. under flushing with nitrogen and with stirring. A vacuum of 200 mbar is then applied for 2 h. The product is then emptied in water and granulated.
Potentiometric titration of the chain ends:
NH₂=0.132 meq/g
COOH=0.013 meq/g, i.e. Mn=13 800 g/mol

The melt viscosity is also measured by oscillatory rheology at 288 Pa·s at 230° C./1 Hz.

### Potentiometric Titration of the Amine Chain Ends

500 mg of polymer are dissolved in 80 g of m-cresol at 130° C. for 1 h.

0.02 N perchloric acid (in acetic acid) is added until neutralization of the amine chain ends. This neutralization is accompanied by a modification of potential, monitored using electrodes.

### Potentiometric Titration of the Acid Chain Ends

1 g of polymer is dissolved in 80 g of tert-butylphenol at 130° C. for 1 h.

0.02 N of tetra-n-butylammonium hydroxide is added until neutralization of the acid chain ends. This neutralization is accompanied by a modification of potential, monitored using electrodes.

### Calculation of the Molecular Weight

The molecular weight is calculated according to the formula below:

Mn=2/([COOH]+[NH₂])

with [COON] and [NH₂] signifying the concentrations of amine and acid chain ends as defined above.

### Viscosity Measurement

The method used is that described in the description above, according to the standard ISO 6721-10: 1999.

Plate-plate: 5% deformation according to the following operating conditions:

Device: PHYSICA MCR301

Geometry: parallel plates with a diameter of 25 mm

Temperatures: 230° C.

Frequency: 100 to 0.01 Hz

Duration: 10 minutes

Atmosphere: Flushing with nitrogen.

### 2/Synthesis of the Copolymer A According to the Invention

The process for preparing the block copolymer A according to the invention is identical to that for the Ref 1 polymer, with the exception of polyamide PA11 which has a molecular weight of 10 300 g/mol.

The proportions are the following:
For the diamine-ended PA11:

| | | |
|---|---|---|
| 11-Aminoundecanoic acid | 33.00 | kg |
| Hexamethylenediamine | 0.353 | kg |
| Water | 5.00 | kg |
| IRGANOX | 33.00 | g |
| 85% H₃PO₄ | 23.3 | g |

For the block copolymer:
   Krasol LBH-P2000: 1.84 kg
   Pripol 1013: 0.985 kg
   PA: 16.70 kg

The chain ends titrated:
For PA 11:
NH₂=0.193 meq/g, i.e. Mn=10 300

For the block copolymer:
NH₂=0.090 meq/g
COOH=0.028 meq/g
i.e. Mn=16 950g/mol

The melt viscosity is also measured by oscillatory rheology at 1310 Pa·s at 230° C./1 Hz.

### 3/Synthesis of the Copolymer B According to the Invention

The Ref1 polymer is added into a co-rotating twin-screw Rheomex PTW 16/25p extruder equipped with a 3 mm-diameter 1-hole die with 0.25% by weight of 3,3′,4,4′-benzophenonetetracarboxylic dianhydride. The screw speed is 400 rpm, the flow rate is 2.5 kg/h and and the mean couple is 30%, and the barrels are heated to a setpoint temperature of 230° C. At the die outlet, the polymer is cooled in a water tank to 23° C. and then granulated.

The chain ends and the Mn of the block polymer obtained are then titrated by potentiometry:
COOH=0.024 meq/g
NH₂=0.104 meq/g
Mn=15 625 g/mol

The melt viscosity is also measured by oscillatory rheology at 1080 Pa·s at 230° C./1 Hz.

TABLE 1

| Copolymer | Melt viscosity (Pa · s) |
|---|---|
| Ref 1 | 288 |
| A | 1310 |
| B | 1080 |

### II. Preparation of the Extruded/Coated Component

By way of example, the covering of a threadlike element with a diameter close to 0.35 mm, for example of a metal cable consisting simply of three elementary single wires 0.18 mm in diameter, twisted together, with a first layer of block copolymer having a maximum thickness equal to approximately 0.25 mm in diameter, for obtaining a sheathed threadlike element having a total diameter of approximately 0.6 mm, is carried out on an extrusion-sheathing line comprising two dies, a first die (counter die or upstream die) of diameter equal to approximately 0.41 mm and a second die (or downstream die) of diameter equal to approximately 0.53 mm, both placed in an extrusion head brought to approximately 210° C.

The block copolymer, melted at a temperature of from 210° C. to 230° C. according to the heating zones of the extrusion screw (Z1=210° C., Z2 =220° C., Z3=230° C., Collier=220° C.) in the extruder, thus covers the threadlike element by means of the sheathing head, at a forward progression speed of the threadlike element typically equal to several tens of m/min, for an extrusion pump flow rate typically of several tens of cm³/min. At the outlet of this sheathing, the threadlike element may be immersed in a cooling tank filled with cold water, in order to solidify and set the polymer in its amorphous state, then dried, for example by passing the take-up reel through an oven.

### III. Tests and Results

### Description of the Adhesion Test

The quality of the bond between the rubber and the composite reinforcers previously manufactured is then assessed by means of a test in which the force required to extract the reinforcers from a vulcanized rubber composition, also termed vulcanizate, is measured. This rubber composition is a conventional composition used for the calendering of metal tire belt plies, based on natural rubber, carbon black and standard additives.

### Rubber Composition Used

The rubber composition comprises 100 phr of natural rubber, 70 phr of carbon black series 300, 1.5 phr of N-1,3-dimethylbutyl-N-phenyl-para-phenylenediamine, 1 phr of a cobalt salt, 0.9 phr of stearic acid, 6 phr of insoluble molecular sulfur, 0.8 phr of N-tert-butyl-2-benzothiazole sulfamide and 7.5 phr of ZnO.

The vulcanizate is a rubber block consisting of two sheets measuring 200 mm by 4.5 mm and with a thickness of 3.5 mm, applied against each other before curing (the thickness of the resulting block is then 7 mm). It is during the production of this block that the composite reinforcers (15 strands in total) are imprisoned between the two rubber sheets in the uncured state, an equal distance apart and with one end of the composite element projecting on either side of these sheets an amount sufficient for the subsequent tensile test. The block comprising the reinforcers is then placed in a suitable mold and then cured under pressure The curing of the block is carried out at 160° C. for 15 min, under a pressure of 16 bar.

After being cured, the test specimen, thus consisting of the vulcanized block and of the 15 reinforcers, is placed between the jaws of a suitable tensile testing machine so as to make it possible to pull each reinforcer individually out of the rubber, at a given rate and a given temperature: at 50 mm/min and 20° C.

The adhesion levels are characterized by measuring the “pull-out” force (denoted Fmax) for pulling the reinforcers out of the test specimen (average over 15 tensile tests).

### 1/ Tensile Test at 23° C.

TABLE 2

| | Fmoy (N/mm²) | Fmax (N/mm²) |
|---|---|---|
| Ref 1 | 14.2 | 15.6 |
| A | 18.9 | 20.2 |
| B | 20.0 | 23.3 |

### 2/Tensile test at 100° C.

TABLE 3

| | Fmoy (N/mm²) | Fmax (N/mm²) |
|---|---|---|
| Ref 1 | 5.8 | 6.6 |

### 3/Tensile test at 120° C.

TABLE 4

| | Fmoy (N/mm²) | Fmax (N/mm²) |
|---|---|---|
| A | 7.5 | 8.2 |
| B | 7.6 | 8.4 |

### IV. Conclusion

These results show that the block copolymer according to the invention makes it possible to obtain an adhesion, whether at ambient temperature or at a higher temperature, which is improved compared with a block copolymer not having the claimed specific viscosity.

1. A block copolymer comprising:
at least one polyamide block,
at least one polyolefin block,
at least one alkylene block derived from a C₂- C₃₆ diacid, and
having a melt viscosity ranging from 300 Pa·s to 20 000 Pa·s, measured at 230° C. by oscillatory rheology.

2. The copolymer as claimed in claim 1, the polyamide block(s) are aliphatic.

3. The copolymer as claimed in claim 1, wherein the polyamide block(s) each have a number-average molecular weight, measured by potentiometery, of between 4 000 and 20 000 g/mol.

4. The copolymer as claimed in claim 1, wherein the polyamide block(s) comprise at least one moiety chosen from PA 6, PA 11, PA12, PA 6.10, PA 6.6, PA 6.12, PA 10.10 and PA 10.12.

5. The copolymer as claimed in claim 1, charactcrizcd in that wherein the polyolefin block(s) each have a viscosity of less than 60 000 cps, the viscosity being measured at 25° C. with a Brookfield instrument and according to the Brookfield method.

6. The copolymer as claimed in claim 1, wherein the polyolefin block(s) are polybutadiene.

7. The copolymer as claimed in claim 1, wherein the alkylene block(s) are fatty acid dimers.

8. The copolymer as claimed in claim 1, wherein the copolymer has the following formula:
PA-(R-Pol-R-PA)ₙ-R-Pol-R-PA
wherein:
n is between 0 and 100,
PA is the polyamide block,
R is the alkylene block, and
Pol is the polyolefin block.

9. The block copolymer as claimed in claim 1,
wherein:
the content of polyamide block is between 2% and 98% by weight relative to the total weight of the block copolymer,
the content of polyolefin block is between 2% and 98% by weight relative to the total weight of the block copolymer, and
the content of alkylene block is between 0.1% and 25%, by weight relative to the total weight of the block copolymer.

10. The copolymer as claimed in claim 1, wherein the block copolymer comprises at least one chain extender block.

11. The copolymer as claimed in the claim 1, wherein the copolymer has the following formula:
X-(copo blocs)-(Ya-A′-Ya)-[(copo blocs)-(Ya-A′-Ya)]m-(copo blocs)-X
wherein:
(copo blocs) denotes the block copolymer as defined in claim 1,
(Ya-A′-Ya) denotes a chain extender Y1-A′-Y1 for which the reactive functions Y1 have reacted with the ends of the block copolymer resulting in Ya functions,
A′ denotes a hydrocarbon-based biradical of non-polymeric structure,
m is an integer between 0 and 100, and
X denotes the free function of the block copolymer.

12. The copolymer as claimed in claim 10, wherein the chain extender is 3,3′,4,4′-benzophenonetetracarboxylic dianhydride.

13. A process for preparing the copolymer as defined in claim 1, comprising a step of mixing the various blocks.

14. The process as claimed in claim 13, comprising the following successive steps:
a step of mixing the polyolefin and alkylene blocks, the molar ratio between the polyolefin blocks and the alkylene blocks being greater than or equal to ½, then
a step of mixing the polyamide block(s) with the mixture obtained in the preceding step.

15. The preparation process as claimed in claim 13, where the process comprises an additional step of mixing the chain extender block(s) with the mixture obtained in the preceding step.

16. A composition comprising at least one block copolymer as defined in claim 1.

17. The composition as claimed in claim 16, wherein the composition is in the form of a powder or of granules.

18. A process for using the composition defined in claim 16, comprising an injecting, extruding or spraying step.

19. A method for conferring anti-corrosion properties on a component comprising a part comprising metal, in which the part is coated with the block copolymer as defined in claim 1.

20. A method for conferring adhesion properties on a component comprising a part comprising metal, in which the part is coated with the block copolymer as defined in claim 1.

21. The method for conferring anti-corrosion and/or adhesion properties on a component comprising a part comprising metal, in which the part is coated with composition as defined in claim 16.
